(19) United States
(12) Patent Application Publication
(10) Pub. No.: US 2008/0213471 A1
(43) Pub. Date: Sep. 4, 2008

(54) Method and apparatus for applying coating solution

(75) Inventors: Kazuhiro Oki, Minami-Ashigara-shi (JP); Masaki Sonobe, Odawara-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJIFILM Corporation, Minato-ku (JP)

(21) Appl. No.: 11/785,618

(22) Filed: Apr. 19, 2007

(30) Foreign Application Priority Data
Apr. 19, 2006 (JP) 2006-115830

(51) Int. Cl. B05D 5/06; B05D 1/30; B05C 5/00

(52) U.S. Cl. 427/162; 427/420; 118/319

(57) ABSTRACT

The present invention provides a method for applying a coating solution by discharging a coating solution from a slit provided at a tip of a slot-die toward a surface of a web fitted onto a backup roller, the method comprising: a stand-by step of staying the slot-die at a stand-by position having a larger clearance between the slot-die and the web than that of a standard coating process; and a two-stage moving operation including a first moving step in which the slot die is moved to a coating initiation position having a smaller clearance than that of the standard coating process to initiate application of a coating solution, and a second moving step in which the slot die is moved away from the coating initiation position to a standard coating position having the clearance of the standard coating process to perform constant application of the coating solution.

### BACKGROUND OF THE INVENTION

1. Field of the Invention

The present invention relates to a method and apparatus for applying a coating solution, and more particularly, a coating initialization technique for accurately and stably forming a thin coating film such as an optical film from the beginning of a coating process.

2. Description of the Related Art

Conventionally, as an apparatus for forming a coating film (coating layer) having a desired thickness on a surface of a web (belt-form substrate), a bar coater system, reverse roll coater system, gravure roll coater system and slot die coater system such as extrusion coater, etc. are known. Of the apparatuses of these systems, the coating apparatus of the slot die coater system is advantageous over other systems because a thin coating film can be obtained at a high speed. By virtue of the advantage, the coating apparatus of the slot die coater system has been widely used in various fields of coating.

In the slot die coater system represented by an extrusion coater, a coating solution is discharged from the tip portion of a slot die and sprayed toward the surface of a web, which is fitted onto a backup roller in continuous motion. In this manner, crosslink of a bead of the coating solution is formed in the clearance between the tip portion of the slot die and the web. The coating solution is applied onto the surface of the web via the bead.

However, in the slot die coater system, since crosslink of the bead of the coating solution is formed in a narrow clearance, disturbance factors such as a manufacturing error of a coating apparatus and vibration produced when the slot die is moved toward the web are likely to have a great effect upon accuracy of coating. In particular, these factors cannot be ignored in forming a thin film such as an optical film uniform in thickness with dimensional accuracy. Various factors influence accuracy of coating with a coating solution. As one of the factors, the interval (also referred to as a “clearance”) between the tip portion of the slot die and the web may be mentioned. The tip portion of the slot die will be hereinafter sometimes referred to as a “lipland”. The clearance generally means the narrowest interval between a web and the peripheral portion of the slot of the slot die from which a coating solution is discharged. When a slot die having an overbite structure is used, the clearance refers to that between the web and the lipland (generally, a downstream-side lipland) positioned closer to the web.

The clearance is a critical factor having a great effect upon the state of the bead of a coating solution. In most cases, the clearance is determined in accordance with the thickness of a film to be formed on the web. For example, in the coating apparatus for applying a coating solution disclosed in Japanese Patent Application Laid-Open No. 10-000421, the clearance employed therein is about 10 fold as thick as a wet-state thickness of a coating film to be formed on the web. Furthermore, in the coating apparatus disclosed in Japanese Patent Application Laid-Open No. 2003-236451, the clearance itself is defined so as to falls generally within the range of about 30 μm to 150 μm.

However, the clearance is the one used in a standard coating process where a coating solution is stably applied to form a film. It is difficult to stably apply a coating solution uniformly from the beginning at which the coating solution rarely forms crosslink in the clearance due to lack of continuous supply of the coating solution. In particular, it is extremely difficult to stably form a thin coating film.

Under these circumstances, several techniques for initiating application of a coating solution to obtain a uniform coating film while preventing a coating failure have been proposed.

For example, Japanese Patent Application Laid-Open No. 5-50002 discloses a method of applying a coating solution by changing the ejection/spray direction of the coating solution by changing the angle of a slot die in the beginning of application of the coating solution. Furthermore, Japanese Patent Application Laid-Open No. 9-141169 discloses a mechanism for moving a support during continuous operation of coating to obtain a uniform coating film without any influence from the physical properties of a coating solution.

### SUMMARY OF THE INVENTION

However, the coating methods of Japanese Patent Application Laid-Open Nos. 2003-236451 and 9-141169 have problems. It is difficult to form a coating film with accuracy from the beginning of a coating process. In particular, in the beginning of the coating process for a thin film, since a coating solution cannot be supplied continuously, the resultant coating film becomes non-uniform in thickness and has irregular coating such as coating streak.

The present invention was contrived in view of the aforementioned conditions. An object of the present invention is to provide a method and apparatus for applying a coating solution capable of forming a film having a uniform thickness from the beginning of application of the coating solution onto a web and suppressing irregular coating such as coating streak.

According to a first aspect of the present invention, to attain the aforementioned object, there is provided a method for applying a coating solution by discharging a coating solution from a slit provided at a tip of a slot-die toward a surface of a web fitted onto a backup roller in continuous motion, thereby forming a crosslink bead of the coating solution in a clearance between the tip of the slot-die and the web, and applying the coating solution to the surface of the web via the bead, the method comprising: a stand-by step of staying the slot-die at a stand-by position having a larger clearance than that of a standard coating process; and a two-stage moving operation including a first moving step in which the slot die is moved to a coating initiation position having a smaller clearance than that of the standard coating process to initiate application of a coating solution, and a second moving step in which the slot die is moved away from the coating initiation position to a standard coating position having the clearance of the standard coating process to perform constant application of the coating solution.

According to the first aspect of the invention, the slot die is stayed in the stand-by position having a larger clearance than that of the standard coating process, and then, moved to the coating initiation position having a smaller clearance than that of the standard coating process (that is, the slot die is moved closer to the web), to initiate application of the coating solution. After crosslink of the coating solution is formed in the clearance and the application coating solution is initiated, the slot die is moved away from the coating initiation position to the standard coating position having the same clearance of the standard coating process (that is, the slot die is moved away from the web), and then standard coating process is performed.

To explain more specifically, the present invention employs two-stage moving operation employing a small clearance than that of the standard coating process and then the clearance of the standard coating process by moving the slot die. By virtue of the two-stage moving operation, it is easy to form a crosslink bead of the coating solution in the clearance in the coating initiation process. Furthermore, even if disturbance such as vibration takes place when the slot-die moves, the crosslink bead can be formed in the clearance stably without fail. Therefore, a film having a uniform thickness can be formed from the beginning of the coating process while suppressing irregular coating such as coating streak. Moreover, the coating solution can be applied in accordance with a wet-state film thickness of the coating film. Note that the “wet-state film thickness” used herein means the film thickness of the wet coating layer, and principally, refers to the film thickness of the coating layer immediately after application of the coating solution on the web until dry.

The method of a second aspect of the invention, which is in accordance with that of the first aspect, is characterized in that, provided that the clearance between the tip of the slot die and the web in the standard coating process is represented by H1 and the clearance between the tip of the slot die and the web in the coating initiation process is represented by H2, a ratio of H2/H1 is not less than 0.5 and less than 1.0.

In the second aspect, the phrase “ratio of H2/H1 is less than 1.0” means that application of a coating solution is initiated when a clearance is smaller than that of the standard coating process. The phrase “ratio of H2/H1 is not less than 0.5” means that the ratio of the clearance of the coating initiation process relative to that of the standard coating process can be preferably reduced to 0.5 at lowest. In other words, if the clearance H2 of the coating initiation process is reduced such that the ratio of H2/H1 is less than 0.5, the web may come into contact with the tip of the slot die. Conversely, if the clearance H2 of the coating initiation process is increased such that the ratio of H2/H1 exceeds 1.0, the bead may not be stably formed at the coating initiation process.

The method of a third aspect of the invention, which is in accordance with that of one of the first and second aspects, is characterized in that, in the first moving step, a moving speed of the slot die falls within the range of 3 mm/sec to 20 mm/sec.

In the third aspect, a preferable moving speed of the first moving step (that is, the slot die is moved toward the web in order to initiate application of a coating solution) is defined. It is preferable that the moving speed falls within the range of 3 mm/sec to 20 mm/sec. This is because, if the moving speed is as low as less than 3 mm/sec, it is likely to form a bead having an uneven thickness in the die width direction (web width direction), with the result that the coating film likely differs in thickness in the web-width direction when application of a coating solution is initiated. In contrast, when the moving speed is as high as beyond 20 mm/sec, the bead may not be stably formed in the coating initiation process, with the result that a trouble such as interruption of coating-solution supply occurs. The more preferable range of the moving speed is 5 mm/sec to 10 mm/sec. Note that it is not necessary to keep the moving speed mentioned above within the entire moving zone from the stand-by position to the coating initiation position. It is sufficient that the moving speed falls within the aforementioned range in the zone from at least 5 mm to the coating initiation position.

The method of a fourth aspect of the invention, which is in accordance with that of any one of the first to third aspects, is characterized in that, in the second moving step, a moving speed of the slot die is 3 mm/sec or less.

In the fourth aspect, a preferable moving speed of the second moving step (after the slot die starts coating at the coating initiation position, it is moved away from the coating initiation position to the standard coating position) is defined. It is preferable that the moving speed is 3 mm/sec or less. This is because, if the moving speed is as high as beyond 3 mm/sec, the size of the bead formed in the clearance tends to vary and the bead is susceptible to influence of degree of vacuum of the vacuum chamber, with the result that the bead, once formed but may be broken.

The method of a fifth aspect of the invention, which is in accordance with that of any one of first to fourth aspects, is characterized in that, retention time, which is time for holding the slot die at the coating initiation position after the slot die reaches the coating initiation position in the first moving step until the slot die starts moving away from the coating initiation position in the second moving step, is 0.5 seconds or more.

Even if the slot die is stayed at the coating initiation position in an extremely short time after application of a coating solution is initiated and immediately moved to the standard coating position, the coating solution can be sufficiently stably applied onto the web. However, if the retention time is less than 0.5 seconds, the bead cannot be stably formed, with the result that supply of the coating solution may be interrupted. Therefore, to form a stable bead in the clearance at the coating initiation position, it is preferable that the retention time is 0.5 seconds or more.

The method of a sixth aspect of the invention, which is in accordance with that of any one of first to fifth aspects, is characterized in that, the coating solution is applied onto the web in an amount sufficient to obtain a wet-state film thickness of 24 μm or less.

This is because the present invention produces an excellent effect in forming a thin coating film having a wet-state film thickness of 24 μm or less.

The method of a seventh aspect of the invention, which is in accordance with that of any one of first to sixth aspects, is characterized in that, provided that the clearance between the tip of the slot die and the web in the standard coating process is represented by H1 and the wet-state film thickness of the coating film formed on the web is represented by h, H1 and h satisfy the relationship: h/H1<0.3.

As is in the case where a thin-layer coating film is formed with dimensional accuracy, it is necessary to reduce the clearance H1 in the standard coating process. In the seventh aspect, a preferable relationship between the film thickness h of the coating film and the clearance H1 in the standard coating process for thin film is defined. In a conventional method, the clearance H1 is set at a value about 10 fold as thick as the film thickness h. However, when the present invention is applied, since the bead can be stably formed in the coating initiation process, the constant coating can be performed even if the ratio of h/H1 is less than 0.3.

The method of an eighth aspect of the invention, which is in accordance with that of any one of first to sixth aspects, is characterized in that, provided that the clearance between the tip of the slot die and the web in the standard coating process is represented by H1 and the wet-state film thickness of the coating film formed on the web is represented by h, H1 and h satisfy the relationship: h/H1<0.15.

In the eighth aspect, the h/H1 ratio according to the seventh aspect is more preferably specifically defined as being less than 0.15.

According to a ninth aspect of the present invention, to attain the aforementioned object, there is provided a method of manufacturing an optical film having at least one coating film layer formed by the method for applying a coating solution according to any one of the first to eighth aspects.

This is because the present invention is particularly effective in forming a thin coating film requiring dimensional accuracy as is in the case of manufacturing an optical film.

According to a tenth aspect of the present invention, to attain the aforementioned object, there is provided an apparatus for applying a coating solution by discharging a coating solution from a slit provided at a tip of a slot-die toward a surface of a web fitted onto a backup roller in continuous motion, thereby forming a crosslink bead of the coating solution in a clearance between the tip of the slot-die and the web, and applying the coating solution to the surface of the web via the bead, the apparatus comprising: a moving device which moves the slot die toward and away from the web; a moving-speed regulating device which regulates a moving speed of the slot die by the moving device; and a control device which controls the moving device to move the slot die to the coating initiation position having a smaller clearance than that of the standard coating process, and stay the slot die at the coating initiation position for a predetermined time, and thereafter, move the slot die to a standard coating position having a clearance of the standard coating process away from the coating initiation position.

The apparatus of an eleventh aspect of the invention, which is in accordance with that of the tenth aspect, is characterized in that, the control device controls the moving device to stop the slot die at the coating initiation position for a retention time of 0.5 seconds or more.

The apparatus of a twelfth aspect of the invention, which is in accordance with that of one of the tenth and eleventh aspects, is characterized in that, the moving-speed regulating device regulates a moving speed of the slot die toward the coating initiation position to fall within the range of 3 mm/sec to 20 mm/sec and a moving speed of the slot die away from the coating initiation position to 3 mm/sec or less.

The tenth to twelfth aspects of the invention are directed to a coating apparatus to which the present invention is applied. Using the apparatus, application of a coating solution can be performed in two-stage moving operation. First, a small clearance than that of the standard coating process is employed for initiating application and then the clearance of the standard coating process is employed by moving the slot die. Therefore, a coating film having a uniform thickness can be formed from the beginning of the coating process while suppressing irregular coating such as coating streak; at the same time, the coating solution can be applied in accordance with the wet-state film thickness of the coating film to be formed.

According to the method and apparatus for applying a coating solution of the invention, the clearance at the coating initiation process is smaller than the standard coating process. By virtue of this, the crosslink of a coating solution in the coating initiation process can be easily formed and the effect of vibration when a slot die moves can be suppressed. Hence, application of a coating solution can be effectively performed in accordance with the thickness of the film to be desired from initiation of the coating process.

Accordingly, the present invention is particularly effective for a method of manufacturing an optical film, which is a thin coating film requiring high dimensional accuracy.

### BRIEF DESCRIPTION OF THE DRAWINGS

FIG. 1 is a view of the entire structure of a coating apparatus of the present invention;

FIG. 2 is an enlarged view of a slot die of the coating apparatus of the present invention including the peripheral portion thereof;

FIG. 3 is a view for explaining how to move the slot die;

FIG. 4 is a view for explaining the steps of moving the slot die;

FIG. 5 is a view of a manufacturing line for an optical compensation film in which the coating apparatus of the present invention is installed;

FIG. 6 is a table showing the conditions and results of Example 1;

FIG. 7 is a table showing the conditions and results of Example 2; and

FIG. 8 is a table showing the conditions and results of Example 3.

### DETAILED DESCRIPTION OF THE PREFERRED EMBODIMENTS

Preferred embodiments of a method and apparatus for applying a coating solution of the present invention will be now explained in accordance with the accompanying drawings.

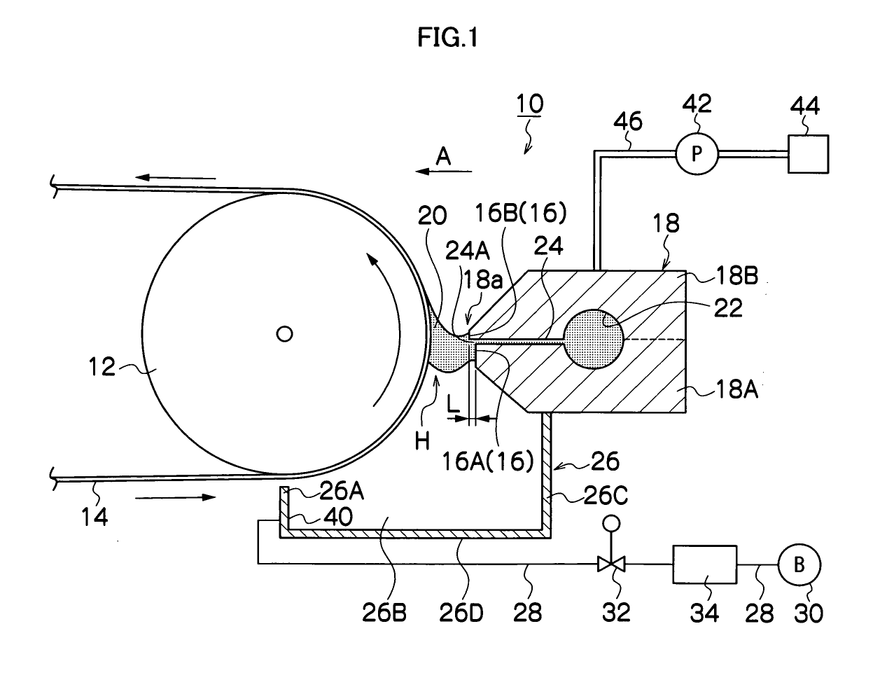

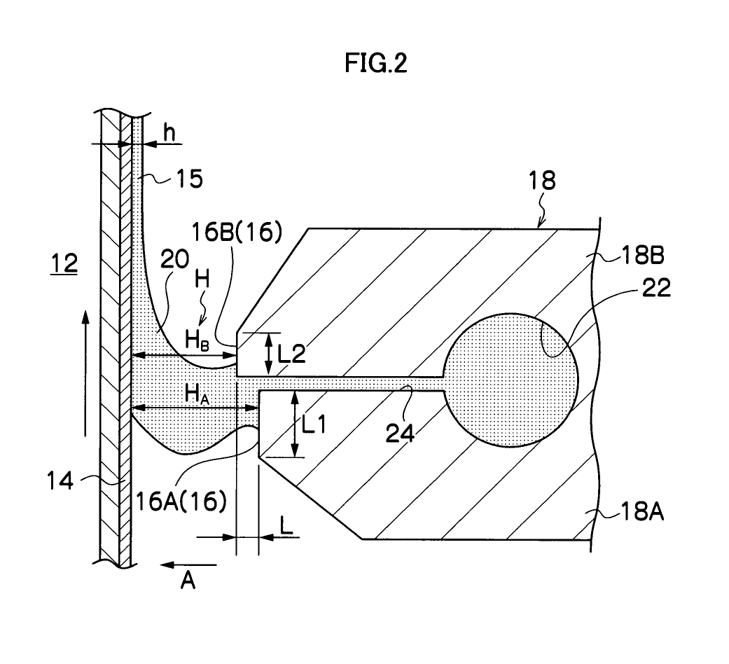

FIG. 1 is a view for explaining the entire structure of a coating apparatus 10 of a slot die coater system according to the present invention. FIG. 2 is an enlarged view showing the tip portion of a slot die and the peripheral portion thereof.

As shown in FIG. 1, a web 14 (belt-type support) is fitted onto a backup roller 12 in continuous motion. A coating solution is discharged from a slot 24 of a slot die 18 and sprayed toward the surface of the web 14. In this manner, crosslink of a bead 20 of the coating solution is formed in the clearance H between the tip 18a of the slot die 18 and the web 14. Subsequently, the portion of the bead 20 positioned on the upstream-side of the web 14 is suctioned by a vacuum chamber 26. While keeping this state, the coating solution of the bead 20 is applied onto the surface of the web 14 in continuous motion to form a coating film (coating layer) 15 on the web 14 (see FIG. 2). It is preferable to provide the vacuum chamber 26, as is shown in this embodiment; however, a slot die 18 having no vacuum chamber 26 may be used in the present invention.

The ahead portion of the web 14 in the direction of moving the web 14 from the position of the bead 20 is designated as a “web upstream portion” and the behind portion thereof is designated as a “web downstream portion”. Accordingly, in the horizontally-long slot die 18 shown in FIG. 1, the lower portion of the bead 20 is the “web upstream portion”, whereas the upper portion of the bead 20 is the “web downstream portion”. The width direction of the web crossed in perpendicular with the moving direction of the web 14 is designated as a “web-width direction”.

A manifold 22 serves as a liquid reservoir for delivering the coating solution supplied to the slot die 18 in the web-width direction. The manifold 22 is formed as void extending in the web-width direction. More specifically, the manifold 22 has a virtually circular sectional shape and consists of a void having a virtually equal sectional shape in the web-width direction. The substantial length of the manifold 22 to the web-width direction is set to be equal to the width of a coating film on the web 14 or longer. Note that the manifold 22 is also called a “pocket”. The manifold 22 is connected to a coating-solution storage tank 44 for storing the coating solution by way of a coating solution supply pipe 46, which is equipped with a coating-solution supply pump 42 for feeding the coating solution from the coating-solution storage tank 44 to the manifold 22, as shown in FIG. 1.

Any method may be used for supplying a coating solution to the manifold 22 as long as it can appropriately supply the coating solution to the manifold 22. For example, the coating solution may be supplied through one end of the manifold 22 or through the middle thereof. Alternatively, the coating solution may be circulated by providing a stopper at both ends of the manifold 22 for preventing leakage of the coating solution and supplying a fresh coating solution through one end and discharging it from the other end and returning it again to the one end. Note that the sectional shape of the manifold 22 is not limited to a virtually circle and may be a semicircle, rectangle such as trapezoid, and analogues of them.

The slot 24 is a narrow flow-channel for a coating solution starting from the manifold 22 to the tip portion 18a of the slot die 18. The slot 24 generally has an opening width of about 0.01 mm to 0.5 mm and longer than the coating width of a coating solution applied onto the web 14 in the web-width direction. The slot 24 ejects a coating solution from an opening port 24A of the tip portion 18a of the slot die 18 and forms crosslink of the bead 20 of the coating solution in the clearance H between the slot die 18 and the web 14. The length of the flow-channel of the slot 24 extending from the manifold 22 toward the web 14 may vary depending upon various conditions such as the composition, physical properties, supply amount and supply pressure of the coating solution. Preferably, the length of the flow-channel of the slot 24 is set such that the coating solution is supplied from the opening port 24A of the slot 24 along the web-width direction at an approximately uniform flow rate and pressure. In the both ends of the slot 24 in the web-width direction, a board for regulating an application-width of a coating solution (not shown in the figure) for regulating the application-width of a coating solution is generally inserted.

In the lower portion of the tip portion 18a of the slot die 18 constructed as mentioned above, a vacuum chamber 26 is provided for reducing the pressure of the bead 20 on the web upstream-side. The vacuum chamber 26 is a box having an inner space constituted of a front plate 26A, side plates 26B, a rear plate 26C and a bottom plate 26D and serving for maintaining a vacuum state.

Of the members constituting the vacuum chamber 26, the front plate 26A is positioned most upstream in the web moving direction and arranged along the width direction of the web 14. The side plates 26B are arranged in perpendicular to the front plate 26A and constitute two side walls of the vacuum chamber 26, respectively. The edge portion (not shown in the figure) of each of the side plates 26B arranged in a close proximity of the backup roller 12 has the same curvature as that of the backup roller 12. The rear plate 26C is arranged under the slot die 18 and virtually in parallel to the front plate 26A. The bottom plate 26D constitutes of the bottom of the vacuum chamber 26 and is in contact with the front plate 26A, side plate 26B, and rear plate 26C at the edge thereof. There are gaps of predetermined-sizes between the front plate 26A and the web 14 and between the side plates 26B and the web 14. The front plate 26A has a suction port 40 which is connected to an air pipe 28.

The vacuum chamber 26 is connected to a blower 30 by way of the suction port 40 and the air pipe 28. In the middle of the air pipe 28, a valve 32 and a buffer unit 34 are provided. The blower 30 evacuates the vacuum chamber 26 to a negative pressure (vacuum) by way of the suction port 40 and the air pipe 28. The degree of vacuum of the vacuum chamber 26 is controlled by opening and closing the valve 32. The buffer unit 34 plays a role as a shock absorber for reducing pressure fluctuation of the vacuum chamber 26.

The slot die 18 is constituted of two die blocks: an upstream-side die block 18A and a downstream-side die block 18B. The manifold 22 and the slot 24 consist part of the border between the upstream-side die block 18A and the downstream-side die block 18B. Likewise, since the slot die 18 is formed of a plurality of blocks, the manufacturing accuracy of the slot die 18 can be improved and post-treatment such as washing can be easily performed. Note that the shape and size of the slot die 18 is specifically determined based on the weight of the slot die, operating environment, the temperature of a coating solution and limits of fabrication specifications.

The tip portion 18a of the slot die 18 is tapered. The tip is called a lipland 16. The lipland 16 at the web upstream-side (the lower side of FIG. 1) of the slot 24 is designated as an upstream-side lipland 16A whereas the lipland 16 at the web downstream-side (the upper side of FIG. 1) is designated as a downstream-side lipland 16B.

As shown in FIG. 2, the vertical length (L1) of the upstream-side lipland 16A generally falls within the range of 100 μm to 1 mm, whereas the vertical length (L2) of the downstream-side lipland 16B falls within the range of 30 μm to 500 μm. The straightness (tolerance) of the lipland 16, that is, the straightness (tolerance) of each of the upstream-side lipland 16A and downstream-side lipland 16B, to the web-width direction is not more than 10 μm and preferably not more than 5 μm per meter.

In the slot die 18 of this embodiment, the interval (H_{A}, hereinafter referred to as the “upstream-side clearance”) between the upstream-side lipland 16A and the web 14, and the interval (H_{B}, hereinafter referred to as the “downstream-side clearance”) between the downstream-side lipland 16B and the web 14 may have the same or different distance. More specifically, the overbite structure shown in FIG. 2 may be employed. The overbite structure is constructed such that the downstream-side lipland 16B is closer to the web 14 fitted on the backup roller 12 than the upstream-side lipland 16A. In this case, the interval H_{A} is larger than that of H_{B}. Such an overbite structure is virtually uniformly formed in the slot die 18 along the entire web-width direction. Note that the distance L between the upstream-side lipland 16A and the downstream-side lipland 16B along the discharging direction of a coating solution (indicated by an arrow A), that is, the distance H_{A}-H_{B}, is called an “overbite amount”. The interval between the downstream-side lipland 16B and the web 14, that is, the most minimum interval between the slot-die tip 18a and the web 14 is called a “clearance”. The distance of the clearance, which is the distance between the web 14 and the downstream-side lipland 16B, generally preferably falls within the range of 20 μm to 200 μm. The overbite amount preferably falls within the range of 0 μm to 150 μm.

In general, when the structure having a narrow clearance between the lipland 16 and web 14 is employed, use of the overbite structure is effective in reducing a pressure loss of the downstream-side coating solution of the bead 20 and lowering a pressure reduction value (degree of vacuum) of the vacuum chamber 26. Therefore, when these structures are used in combination, fluctuation of the bead 20 can be suppressed and the coating solution can be stably applied onto the web 14. As a result, a coating film having an accurate planar surface (extremely flat surface) can be provided.

To satisfy the aforementioned shape and improve the strength and surface state of the tip portion of the lipland, a slot die 18 including at least the tip portion of the lipland is preferably formed of an super-hard material containing tungsten carbide (hereinafter referred to as “WC”) as a main component, or may be formed of a metal material such as stainless steel. Such a super-hard material is effective in view of not only the uniformity of surface state but also preventing abrasion of the lipland with a coating solution constantly discharged. In particular, the use of a super-hard material is effective in the case of using a magnetic coating solution containing a polishing agent as a coating solution. As the super-hard material, WC carbonized crystals (an average particle size: 5 μm) bonded by a binding metal such as Co is used. The binding metal is not limited to Co and various types of metals such as Ti, Ta and Nb may be used. Any WC carbonized crystals may be used as long as they have an average particle size of 5 μm or less.

Next, the interval (clearance) between the lipland 16 of the slot die 18 and web 14 will be explained.

The extrusion-type die coater having an overbite structure generally has a coating limit represented by Formula (1) below.

$$\frac{1}{2} ( \frac{d}{h} - 1 ) {( \frac{μν}{σ} )}^{\frac{2}{3}} < \frac{1}{1.34} \qquad [ Formula 1 ]$$

where “h” represents the thickness of a wet-state coating film 15, “μ” represents the viscosity of a coating solution, “σ” represents the surface tension of the coating solution and “v” represents a coating speed (web moving speed).

As is represented by Formula (1), the maximum downstream-side clearance H_{B} (see FIG. 2) over which a coating solution can reach to the web is determined depending upon the wet-state film thickness h of the coating film 15, the viscosity μ of a coating solution, the surface tension σ of the coating solution and coating speed v. Therefore, if the downstream-side clearance H_{B} is set at a width which is 30 times as large as the wet-state film thickness h of the coating film 15, for example, a coating speed V must be lowered. This is not preferable in view of manufacturing the coating film 15 efficiently in a large amount.

The present inventors investigated based on the aforementioned points. As a result, they found the followings. It is preferable that the downstream-side clearance H_{B} of the coating initiation process is set to be smaller than the clearance H_{B} of the standard coating process in view of preventing supply of a coating solution from being interrupted. After coating is started, the clearance is controlled to be back to the clearance H_{B} of the standard coating process. In this manner, the supply of the coating solution can be prevented from being interrupted. The term “standard coating process” used herein refers to a standard coating process at which a coating solution can be stably applied onto the web 14. Also, “standard coating process” means the production process.

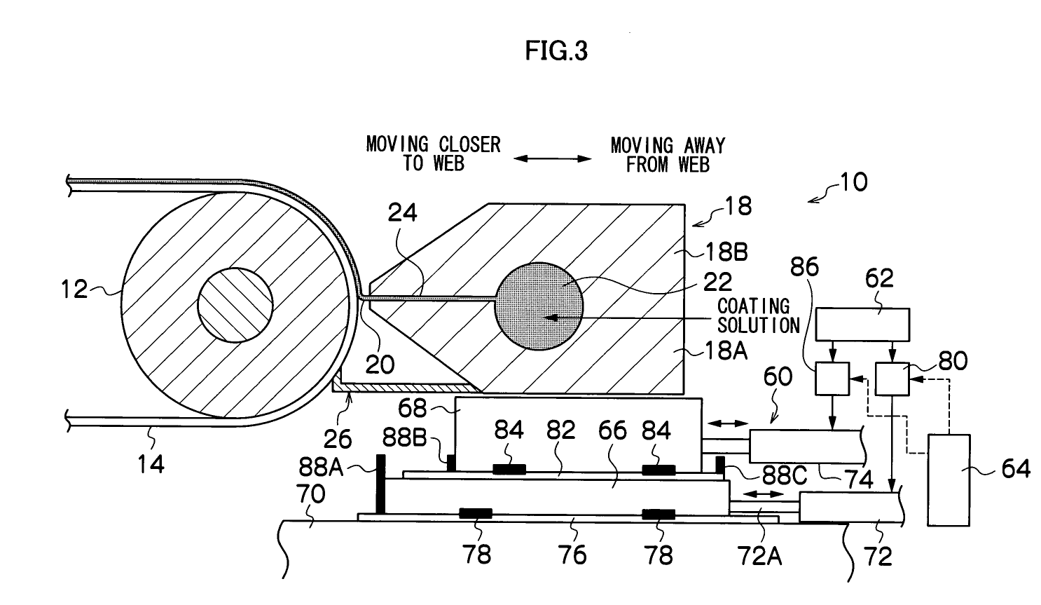

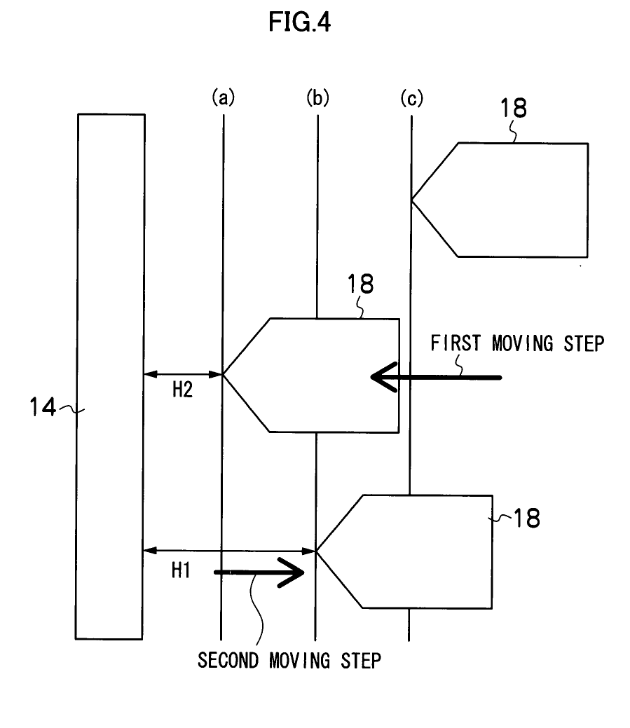

The present inventors constructed a moving system for a slot die 18 of the coating apparatus 10 based on the aforementioned findings. FIG. 3 is a view for explaining how to move the slot die 18 and FIG. 4 is a view for explaining the steps of moving the slot die 18.

As explained in FIG. 3, the moving mechanism for the slot die 18 is principally constituted of a moving device 60 which moves the slot die 18 toward and away from the web 14, a moving-speed regulating device 62 which regulates a moving speed of the slot die 18 by the moving device 60, and a control device 64 for controlling the moving device 60.

FIG. 3 shows the case where first and second hydraulic cylinders 72, 74 are used as the moving device 60. The hydraulic cylinders 72, 74 are used for lower and upper stages 66, 68, on which the slot die 18 is mounted, on a base table 70. A pair of rails 76 are provided on the base table 70 and extended in the direction perpendicular to the shaft direction of the backup roller 12. On the rails 76, the lower stage 66 is slidably mounted via linear bearings 78. To one of the sides of the lower stage 66, the tip of the piston rod 72A of the first hydraulic cylinder 72 is connected. The first hydraulic cylinder 72 is connected to the moving-speed controlling device 62 via a first hydraulic circuit 80. The stroke of the piston rod 72A of the first hydraulic cylinder 72 is set to be equal to the distance from a stand-by position (c) to a standard coating position (b) of FIG. 4.

On the lower stage 66, a pair of rails 82 are provided and extended in the direction perpendicular to the shaft direction of the backup roller 12. On the rails 82, the upper stage 68 is slidably mounted via linear bearings 84. On the upper stage 68, a slot die 18 is amounted. To one of the sides of the upper stage 68, the tip of the piston rod 74A of the second hydraulic cylinder 74 is connected. The second hydraulic cylinder 74 is connected to the moving-speed controlling device 62 via a second hydraulic circuit 86. The stroke of the piston rod 74A of the second hydraulic cylinder 74 is set to be equal to the distance from the standard coating position (b) to a coating initiation position (a) of FIG. 4.

Furthermore, the first and second hydraulic circuits 80, 86 are connected to the control device 64. The control device 64 is controls the piston rods 72A, 74A of the first and second hydraulic cylinder 72, 74 by way of the first and second hydraulic circuits 80, 86 as follows. As shown in FIG. 4, the slot die 18 is stayed at the stand-by position (c). When the operation of a coating process starts, a coating solution is discharged from the slot 24 of the slot die 18. In this state, the control device 64 controls the first and second hydraulic cylinder 72, 74 to move the slot die 18 placed at the stand-by position (c) toward the coating initiation position (a) (the clearance is smaller than that in standard coating process) and stop the slot die 18 at the coating initiation position (a) (First moving step). By this operation, crosslink of a bead of the coating solution is formed in the clearance H between the slot-die tip 18a and the web 14 and application of a coating solution is initiated. In moving the slot die 18 herein, the moving-speed regulating device 62 regulates the elongation speeds of piston rods 72A, 74A of the first and second hydraulic cylinders 72, 74 such that the slot die 18 moves at a speed within the range of 3 mm/sec to 20 mm/sec.

Subsequently, the control device 64 controls the slot die 18 to stay at the coating initiation position (a) for at least one second. In this manner, the crosslink of the bead is stabilized.

Next, the control device 64 controls the second hydraulic cylinder 74 to move the slot die 18 from the coating initiation position (a) to the standard coating position (b) (Second moving step). In this manner, constant application of a coating solution is initiated. In moving the slot die 18 herein, the moving-speed regulating device 62 regulates the elongation speed of the piston rod 74A of the second hydraulic cylinder 74 such that the slot die moves at a speed of 3 mm/sec or less.

The slot die 18 is stopped at the coating initiation position (a) and the standard coating position (b) by setting the stroke lengths of the piston rods 72A, 74A of the first and the second hydraulic cylinders 72, 74. The stop operation of the slot die 18 can be controlled accurately by providing stoppers 88A, 88B, 88C on the upper stage 68 and lower stage 66 as shown in FIG. 3. The stopper 88C is used for positioning the slot die 18 moving away from the web 14 in the second moving step at the standard coating position (b) by hitting the slot die 18 thereto.

Note that, in FIG. 3, the hydraulic cylinders 72, 74 are used for moving the slot die 18; however, the moving system is not limited to these. Any moving system may be employed as long as it can accurately move and stop the slot die at the coating initiation position (a) and the standard coating position (b) within the aforementioned moving-speed range. For example, a moving system may be constructed of a servo motor in combination with a ball screw. Alternatively, the slot die 18 is fixed and the backup roller 12 for mounting the web 14 can be moved.

By virtue of the moving system, a coating film can be formed uniform in thickness from the coating initiation process at which application of a coating solution to the web 14 is initiated. In addition, irregularity such as coating streak can be suppressed. Note that the present invention is not limited to the slot die 18 having an overbite structure and may be applied onto the slot die 18 having no overbite structure.

The web 14 and the coating solution used in this embodiment, may contain various types of components depending upon the object. Examples of the web include band-form substrates having an additional processing layer formed on the surface thereof, flexible materials and composite materials formed by laminating these. Examples of the substrate of the web include known plastic films such as polyethylene terephthalate (PET), polyethylene-2,6-naphthalate, cellulose diacetate, cellulose triacetate, cellulose acetate propionate, polyvinyl chloride, polyvinylidene chloride, polycarbonate, polyimide and polyamide; paper sheets; laminate paper sheets formed by coating or laminating α-polyolefins having 2 to 10 carbon atoms such as polyethylene, polypropylene and ethylene-butene copolymer; metal foils such as aluminum, copper and tin.

Examples of a solvent for a coating solution include water, various types of halogenated hydrocarbons, alcohols, ethers, esters, and ketones, singly or in a mixture of two or more types.

An embodiment of the present invention has been explained in the above. Various modifications such as variation in design may be added and known elements may be applied based on the knowledge of those skilled in the art. Such modified and changed embodiments are also encompassed in the scope of the present invention.

For example, the backup roller 12, slot die 18 and vacuum chamber 26 may be arranged in any manner as long as they can be used for applying a coating solution appropriately onto the web 14. For example, an ejection angle of a coating solution from the slot die 18 toward the web 14, a sectional shape of the manifold 22, the state of the web 14 putting over the backup roller 12, relative positional relationships between the web 14 fitted onto the backup roller 12 and the slot die 18 and between the web 14 fitted onto the backup roller 12 and the vacuum chamber 26, and the overbite amount (including an overbite amount of zero) can be appropriately controlled depending upon the object.

### EXAMPLES

Examples using the coating apparatus of the present invention will be described below; however the present invention will not be limited to the Examples. In the examples, a coating solution for an optical compensation film was applied by the coating apparatus of the present invention, which was installed in a manufacturing line for an optical compensation film.

A web and a coating solution for an optical compensation film were prepared as follows.

### <Preparation of Web>

The following composition was posted in a mixing tank. The mixture was heated to 30° C. with stirring to melt components of the composition to prepare a cellulose acetate solution.

| Components of cellulose acetate solution | Inner layer | Outer layer |
|---|---|---|
| (parts by mass) | dope | dope |
| Cellulose acetate (acetylation degree: 60.9%) | 100 parts | 100 parts |
| Triphenylphosphate (plasticizer) | 7.8 parts | 7.8 parts |
| Biphenyldiphenylphosphate (plasticizer) | 3.9 parts | 3.9 parts |
| Methylene chloride (first solvent) | 293 parts | 314 parts |
| Methanol (second solvent) | 71 parts | 76 parts |
| 1-butanol (third solvent) | 1.5 parts | 1.6 parts |
| Silica fine particles (AEROSIL R972, | 0 part | 0.8 parts |
| manufactured by Nippon Aerosil Co., Ltd) | | |
| Retardation improver | 1.7 parts | 0 part |

The obtained inner-layer dope and outer-layer dope were applied by flow-casting on a drum cooled to 0° C. by use of a triple-layer flow casting die. The resultant film containing a residual solvent of 70% by mass was peeled off from the drum. Both ends of the film were fixed onto a pin tenter. The film was dried at 80° C. while transferring the film at a draw ratio of 110% in the transferring direction. When the residual solvent becomes 10%, the film was dried at 110° C. Thereafter, the film was dried at 140° C. for 30 minutes. In this manner, a cellulose acetate film having a residual solvent of 0.3% by mass (the upper outer layer: 3 μm thick, the inner layer: 74 μm thick, the lower outer layer: 3 μm thick) was manufactured.

The width of the obtained cellulose acetate film was 1340 mm and the thickness was 80 μm. When the retardation value (Re) of the film at a wavelength of 500 nm was analyzed by an ellipsometer (M-150, manufactured by JASCO Corporation), it was 6 nm. The retardation value (Rth) of the film measured at a wavelength of 500 nm was 90 nm.

### <Saponification Treatment>

The cellulose acetate film was passed through a dielectric heating roller of 60° C. After the temperature of the surface of the film was increased to 40° C., an alkaline solution having the following composition was applied by a bar-coater to the film at a rate of 14 m/m². The film was stayed under a steam-type far infrared ray heater (manufactured by Noritake Co., Ltd.) heated to 110° C. for 10 seconds. Thereafter, pure water was similarly applied by a bar coater at a rate of 3 ml/m². At the time, the temperature of the film was 40° C. Subsequently, the film was washed with water by a fountain coater and dewatered by an air knife. This operation was repeated three times, and then, the film was dried by staying it in a dry zone at 70° C. for 2 seconds.

### <Composition of Alkaline Solution>

Potassium hydroxide . . . 4.7 parts by mass
Water . . . 15.7 parts by mass
Isopropanol . . . 64.8 parts by mass
Propylene glycol . . . 14.9 parts by mass
C₁₆H₃₃O(CH₂CH₂O)₁₀H (surfactant) . . . 1.0 part by mass

Thereafter, a coating solution for an orientation layer having the following composition was applied by a #16-wire bar coater at a rate of 28 mL/m². The film was dried with hot air of 60° C. for 60 seconds and further with hot air of 90° C. for 150 seconds, and then rolled up. In this manner, a long web formed of the cellulose acetate film having an orientation film attached thereon was formed.

### <The Composition of Orientation-Layer Coating Solution>

Modified polyvinyl alcohol . . . 20 parts by mass
Water . . . 360 parts by mass
Methanol . . . 120 parts by mass
Glutaraldehyde (crosslinking agent) . . . 1.0 part by mass

### <Preparation of Coating Solution for Optical Compensation Film>

The following composition was dissolved in methylethyl ketone (107 parts by mass) to prepare the coating solution. The viscosity of the coating solution was adjusted to a desired value by controlling the content of methylethyl ketone.
Discotic liquid crystal compound TE (1) . . . 41.01 parts by mass
Ethylene oxide modified trimethylol propane triacrylate (V#360, manufactured by Osaka Organic Chemical Industry Ltd.) . . . 4.06 parts by mass
Cellulose acetate butyrate (CAB551-0.2, manufactured by Eastman Chemical Company) . . . 0.9 parts by mass
Cellulose acetate butyrate (CAB531-1, manufactured by Eastman Chemical Company) . . . 0.21 parts by mass
Fluoroaliphatic group containing polymer (Megafac F780 manufactured by Dainippon Ink and Chemicals Incorporated) . . . 0.14 parts by mass
Photopolymerization initiator (Irugacure 907 manufactured by Ciba Geigy) . . . 1.35 parts by mass
Sensitizer (Kayacure DETX manufactured by Nippon Kayaku Co. Ltd.) . . . 0.45 parts by mass

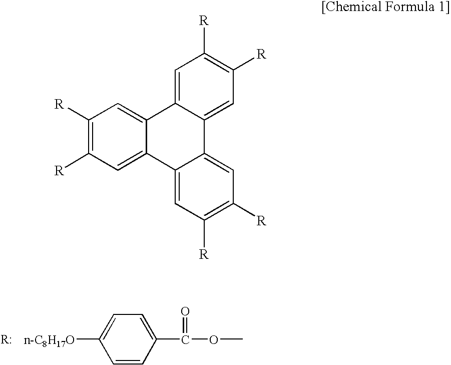

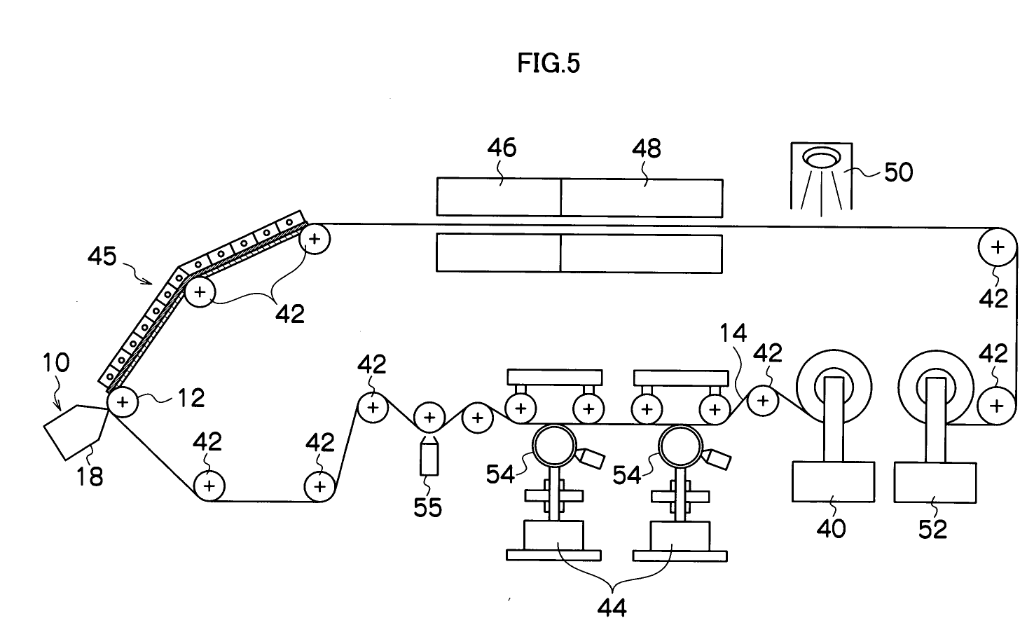

The optical compensation film manufacturing line is shown in FIG. 5. A web 14, which is a transparent substrate having a polymer layer for an orientation film previously formed thereon is fed out from a feeder 40. The web 14 is guided by a guide roller 42 and fed into a rubbing process unit 44. Rubbing rollers 54 are provided for rubbing the polymer layer. The film is rubbed by the rubbing roller 54 at a rotation number of 400 rpm. Downstream of the rubbing roller 54, a dust remover 55 is provided for removing dust attached to the surface of the orientation film of the web 14. Downstream of the dust remover 55, a coating apparatus 10 according to the present invention is provided. In the coating apparatus 10, a coating solution for an optical compensation film containing a disco-nematic liquid crystal is applied onto the web 14. Downstream of the coating apparatus 10, a dry unit 45 which dries the film immediately after coating, a post dry unit 46, and a heating unit 48 are provided sequentially in this order. Through these units, a liquid crystal layer is formed on the web 14. In the heating unit 48, the film is heated at 135° C. for about 90 seconds. A UV lamp 50 is provided downstream the heating unit 48. The film having a surface temperature of about 100° C. is irradiated with UV rays having an illuminance of 600 mW by a UV irradiation unit (UV lamp: output power 160 W/cm, emission length: 1.6 m) for 4 seconds. In this manner, crosslinking reaction is performed and the orientation of the discotic liquid crystal compounds is fixed. The web 14 on which the coating solution for an optical compensation film is applied is rolled up by a roller 52 provided downstream.

### Example 1

In Tests 1 to 23 of Example 1, the coating method of the present invention was performed using the coating apparatus of the present invention by changing various factors as mentioned below. The form and state of the bead at the coating initiation process, at which the coating solution shown below was applied onto a web, and the state of the coating film formed on the web were observed and evaluated. Evaluation results were shown by evaluation scores: E (excellent), G (good), NG (no good), and P (poor).

Evaluation score E denotes that a bead of a coating solution was formed in the clearance from the coating initiation process; no irregular coating such as coating streak was observed on the coating surface; and the dimensional accuracy of the resultant film with respect to thickness is less than ±0.5% relative to a reference desired film-thickness.

Evaluation score G denotes that a bead of a coating solution was formed in the clearance from the coating initiation process; little irregular coating such as coating streak was observed on the coating surface; and the dimensional accuracy of the resultant film with respect to thickness is from not less than ±0.5% to less than ±1.0% relative to a reference desired film-thickness.

Evaluation score NG denotes that a bead of a coating solution was formed in the clearance from the coating initiation process; irregular coating such as coating streak was observed on the coating surface; and the dimensional accuracy of the resultant film with respect to thickness is from not less than ±1.0% relative to a reference desired film-thickness.

Evaluation score P denotes that no bead of a coating solution is formed in the clearance since supply of a coating solution is interrupted.

In the tests, the following 4 factors are changed.

(A) the relationship H2/H1 where H2 represents the clearance between the slot-die tip and the web at the coating initiation process, and H1 represents clearance between the slot-die tip and the web in the standard coating process. The relationship H2/H1 preferably falls within the range of not less than 0.5 to less than 1.0.

(B) The retention time of the slot die at the coating initiation position (a), in other words, the time after the slot die reaches the coating initiation position (a) in the first moving step until the slot die starts moving away from the coating initiation position (a) in the second moving step. The retention time preferably falls within the range of 0.5 seconds or more.

(C) The moving speed of the slot die from the stand-by position (c) toward the coating initiation position (a) in the first moving step. The moving speed preferably falls within the range of 3 mm/sec to 20 mm/sec.

(D) The moving speed of the slot die away from the coating initiation position (a) toward the standard coating position (b) in the second moving step. The moving speed preferably falls within the range of 3 mm/sec or less.

Coating conditions of Example 1 are shown in Table 1

TABLE 1

| Coating speed | 50 | m/min |
|---|---|---|
| Wet-state film thickness h of coating film | 7.5 | μm |
| Coating width | 1000 | mm |
| Downstream-side clearance | 80 | μm |
| Overbite amount | 100 | μm |
| Downstream lipland length | 100 | μm |
| Slot width | 200 | μm |
| Material for width-regulating board | SUS630 | |
| Degree of vacuum of vacuum chamber | 800 | Pa |

| | |
|---|---|
| Material for web | Triacetylcellulose (TAC) |

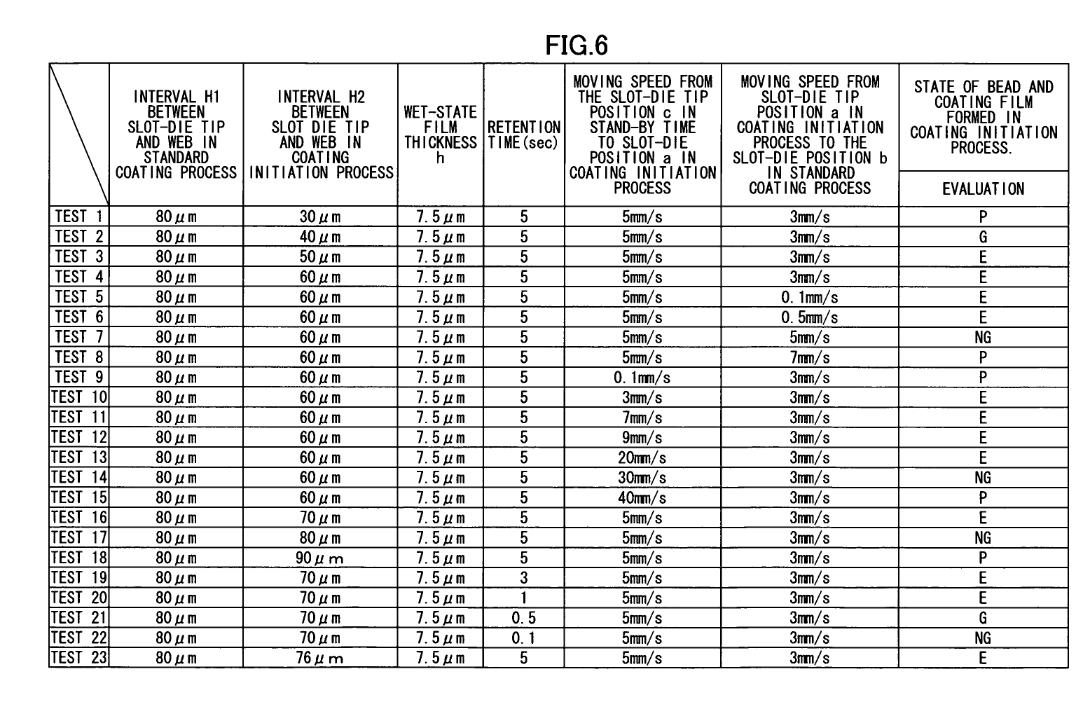

Test results are shown in FIG. 6.

Of the test zones of Tests 1 to 23, in Tests 1 to 18 and 23, factor (A) is changed, more specifically, the ratio of H2/H1 is changed from 0.37 to 1.13. In Tests 4 to 8, factor (D) is changed, more specifically, the moving speed of the slot die away from the coating initiation poison (a) is changed from 0.1 to 7 mm/sec. In Tests 9 to 15, factor (C) is changed, in other words, the moving speed of the slot die toward the coating initiation position (a) is changed from 0.1 to 40 mm/sec. Test 16 follows the standard conditions of the present invention. In Tests 17 to 22, the factor (B) is changed, in other words, the retention time is changed from 0.1 to 5 seconds.

In Test 1 shown in FIG. 6, the ratio of H2/H1 is 0.38. As is in Test 1, in the case where the ratio of H2/H1 (the ratio of clearance H2 at the coating initiation process relative to clearance H1 at the standard coating process) is as small as less than 0.5, evaluation score P is given. A bead is not formed in this case. Conversely, as is in Tests 17 and 18, in the case where the ratio of H2/H1 is 1.0 or more, evaluation scores NG and P are given. Also, good evaluation is not obtained. As is in Test 23, in the case of where the ratio of H2/H1 is 0.95, evaluation score E is given. Likewise, if the ratio of H2/H1 is even slightly low than 1.0, good evaluation is obtained.

As is in Tests 7 and 8, in the case where the moving speed of the slot die away from the coating initiation position in the second moving step is as fast as beyond 3 m/s, evaluation scores NG and P are given. Evaluation are not good. As is in Tests 9, 14 and 15, in the case where the moving speed of the slot die toward the coating initiation position in the first moving step is too low and too high, evaluation scores NG and P are given. Evaluation are not good, either. Furthermore, the case where the retention time is 0.5 seconds as is in Test 21, good evaluation G is given. However, the case where the retention time is 0.1 second as is in Test 22, evaluation score NG (not good) is given.

In contrast, in Tests 2 to 6, 10 to 13, 16 (standard conditions) and 19 to 21 and 23 all satisfying the aforementioned preferable conditions with respect to factors (A), (B), (C) and (D), good evaluation scores G to E are given.

### Example 2

In Example 2, Test 24 to 36, 41, 42 and 44 were performed by changing the conditions: the wet-state thickness h of a film formed of a coating solution applied onto a web, coating speed (moving speed of a web), the viscosity of the coating solution, and surface tension of the coating solution, while satisfying preferable ranges of the factors (A), (B), (C) and (D) of Example 1.

For comparison, Tests 37 to 40 and 43 were performed which were all outside the preferable range with respect to factor (A), that is, the ratio H2/H1 was 1.0.

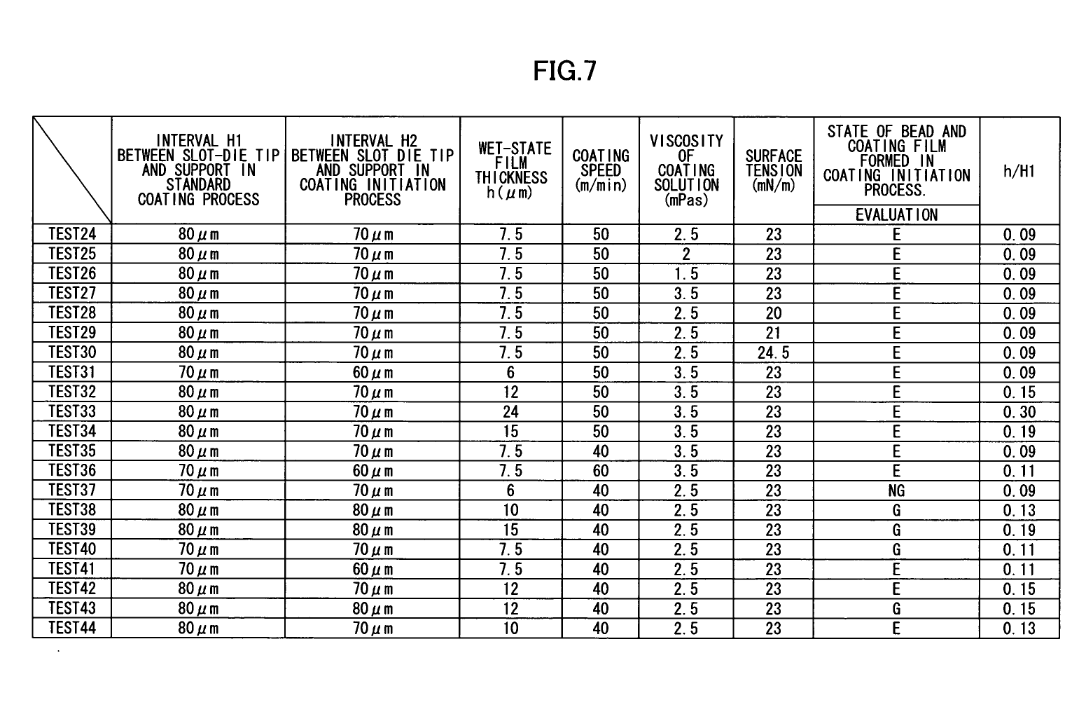

The test results are shown in FIG. 7. In Tests 24 to 27, the viscosity of a coating solution is changed. In Tests 28 to 30, the surface tension of a coating solution is changed. In Tests 31 to 34 and 37 to 44, the wet-state thickness h of a coating film is changed. In Tests 35 and 36, a coating speed is changed.

As is apparent from FIG. 7, in Tests 24 to 36, 41, 42, 44, as long as preferable ranges of factors (A), (B), (C) and (D) of Example 1 are satisfied, even if various conditions: the wet-state thickness h, coating speed, the viscosity and surface tension of the coating solution, are changed, a good evaluation score E is given. From the results of Test 33 where the wet-state film thickness h is 24 μm, it is found that the present invention produces a further excellent effect in a thin coating film of 24 μm or less. Furthermore, Tests 37 to 40 and Test 43 where a ratio of H2/H1 is 1.0 are mutually compared. When the wet-state film thickness h is as large as 10 to 15 μm, a good evaluation score G is obtained even though the two-stage moving operation of the present invention is not used. However, the evaluation score (G) of these cases are lower than that (E) of the case of the present invention employing the two-stage moving operation. In particular, in the case where the wet-state film thickness h is as low as 6 μm, as is Test 37, if the two-stage moving operation is not employed, the evaluation score decreases to NG.

### Example 3

In Example 3, the coating conditions of Table 1 were changed to those shown in Table 2.

TABLE 2

| Coating speed | 60 | m/min |
|---|---|---|
| Wet-state film thickness h of coating film | 7.0 | μm |
| Coating width | 1200 | mm |
| Downstream-side clearance | 70 | μm |
| Overbite amount | 70 | μm |
| Downstream lipland length | 60 | μm |
| Slot width | 140 | μm |
| Material for width-regulating board | SUS630 | |
| Degree of vacuum of vacuum chamber | 950 | Pa |

| | |
|---|---|
| Material for web | Triacetylcellulose (TAC) |

Of the factors (A), (B), (C) and (D) of Example 1, only factor (A) was changed in this Example. A ratio of H2/H1 is 0.86 in Test 45, 1.0 in Test 46 and 1.1 in Test 47.

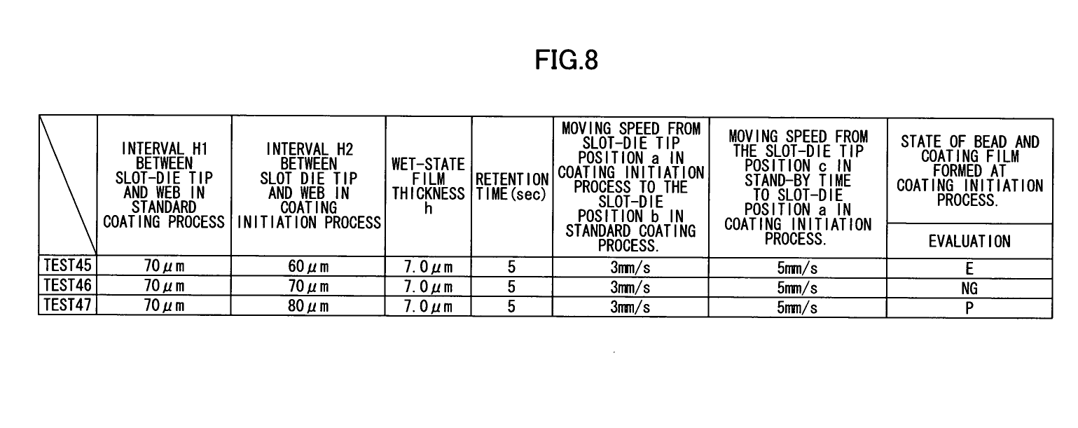

The test results are shown in FIG. 8. As is apparent from FIG. 8, in Test 45 where a first moving step where coating is started by moving a slot die to the coating initiation position (a) (the clearance H2 at the coating initiation process is lower than the clearance H1 at the standard coating process) and a second moving step where the slot die is moved to the standard coating position (b) having the clearance H1 in the standard coating process are carried out, that is, the two-stage moving operation is carried out, a good evaluation score E is obtained.

In contrast, in Tests 46 and 47, where the two-stage moving operation (first and second moving steps) is not performed, that is, coating is started from the standard coating position (b) by moving a slot die to the position (b) from the beginning, the evaluation scores are not good (NG and P).

As is apparent from Examples 1 to 3, a film having a uniform thickness can be formed from the coating initiation process at which application of a coating solution to a web is started while suppressing formation of irregular coating such as coating streak in the present invention by performing a method of the present invention based on two-stage moving operation consisting of a first and second moving steps while controlling additional factors such as a moving speed.

What is claimed is:

1. A method for applying a coating solution by discharging a coating solution from a slit provided at a tip of a slot-die toward a surface of a web fitted onto a backup roller in continuous motion, thereby forming a crosslink bead of the coating solution in a clearance between the tip of the slot-die and the web, and applying the coating solution to the surface of the web via the bead, the method comprising:
a stand-by step of staying the slot-die at a stand-by position having a larger clearance than that of a standard coating process; and
a two-stage moving operation including
a first moving step in which the slot die is moved to a coating initiation position having a smaller clearance than that of the standard coating process to initiate application of a coating solution, and
a second moving step in which the slot die is moved away from the coating initiation position to a standard coating position having the clearance of the standard coating process to perform constant application of the coating solution.

2. The method for applying a coating solution according to claim 1, wherein
provided that the clearance between the tip of the slot die and the web in the standard coating process is represented by H1 and the clearance between the tip of the slot die and the web in the coating initiation process is represented by H2, a ratio of H2/H1 is not less than 0.5 and less than 1.0.

3. The method for applying a coating solution according to claim 1, wherein,
in the first moving step, a moving speed of the slot die falls within the range of 3 mm/sec to 20 mm/sec.

4. The method for applying a coating solution according to claim 2, wherein,
in the first moving step, a moving speed of the slot die falls within the range of 3 mm/sec to 20 mm/sec.

5. The method for applying a coating solution according to claim 1, wherein,
in the second moving step, a moving speed of the slot die is 3 mm/sec or less.

6. The method for applying a coating solution according to claim 2, wherein,
in the second moving step, a moving speed of the slot die is 3 mm/sec or less.

7. The method for applying a coating solution according to claim 3, wherein,
in the second moving step, a moving speed of the slot die is 3 mm/sec or less.

8. The method for applying a coating solution according to claim 1, wherein
retention time, which is time for holding the slot die at the coating initiation position after the slot die reaches the coating initiation position in the first moving step until the slot die starts moving away from the coating initiation position in the second moving step, is 0.5 seconds or more.

9. The method for applying a coating solution according to claim 2, wherein
retention time, which is time for holding the slot die at the coating initiation position after the slot die reaches the coating initiation position in the first moving step until the slot die starts moving away from the coating initiation position in the second moving step, is 0.5 seconds or more.

10. The method for applying a coating solution according to claim 3, wherein
retention time, which is time for holding the slot die at the coating initiation position after the slot die reaches the coating initiation position in the first moving step until the slot die starts moving away from the coating initiation position in the second moving step, is 0.5 seconds or more.

11. The method for applying a coating solution according to claim 5, wherein
retention time, which is time for holding the slot die at the coating initiation position after the slot die reaches the coating initiation position in the first moving step until the slot die starts moving away from the coating initiation position in the second moving step, is 0.5 seconds or more.

12. The method for applying a coating solution according to claim 1, wherein
the coating solution is applied onto the web in an amount sufficient to obtain a wet-state film thickness of 24 μm or less.

13. The method for applying a coating solution according to claim 2, wherein
the coating solution is applied onto the web in an amount sufficient to obtain a wet-state film thickness of 24 μm or less.

14. The method for applying a coating solution according to claim 3, wherein
the coating solution is applied onto the web in an amount sufficient to obtain a wet-state film thickness of 24 μm or less.

15. The method for applying a coating solution according to claim 5, wherein
the coating solution is applied onto the web in an amount sufficient to obtain a wet-state film thickness of 24 μm or less.

16. The method for applying a coating solution according to claim 8, wherein
the coating solution is applied onto the web in an amount sufficient to obtain a wet-state film thickness of 24 μm or less.

17. The method for applying a coating solution according to claim 1, wherein,
provided that the clearance between the tip of the slot die and the web in the standard coating process is represented by H1 and the wet-state film thickness of the coating film formed on the web is represented by h, H1 and h satisfy the relationship: h/H1<0.3.

18. The method for applying a coating solution according to claim 2, wherein,
provided that the clearance between the tip of the slot die and the web in the standard coating process is represented by H1 and the wet-state film thickness of the coating film formed on the web is represented by h, H1 and h satisfy the relationship: h/H1<0.3.

19. The method for applying a coating solution according to claim 3, wherein,
provided that the clearance between the tip of the slot die and the web in the standard coating process is represented by H1 and the wet-state film thickness of the coating film formed on the web is represented by h, H1 and h satisfy the relationship: h/H1<0.3.

20. The method for applying a coating solution according to claim 5, wherein,
provided that the clearance between the tip of the slot die and the web in the standard coating process is represented by H1 and the wet-state film thickness of the coating film formed on the web is represented by h, H1 and h satisfy the relationship: h/H1<0.3.

21. The method for applying a coating solution according to claim 8, wherein,
provided that the clearance between the tip of the slot die and the web in the standard coating process is represented by H1 and the wet-state film thickness of the coating film formed on the web is represented by h, H1 and h satisfy the relationship: h/H1<0.3.

22. The method for applying a coating solution according to claim 12, wherein,
provided that the clearance between the tip of the slot die and the web in the standard coating process is represented by H1 and the wet-state film thickness of the coating film formed on the web is represented by h, H1 and h satisfy the relationship: h/H1<0.3.

23. The method for applying a coating solution according to claim 1, wherein,
provided that the clearance between the tip of the slot die and the web in the standard coating process is represented by H1 and the wet-state film thickness of the coating film formed on the web is represented by h, H1 and h satisfy the relationship: h/H1<0.15.

24. The method for applying a coating solution according to claim 2, wherein,
provided that the clearance between the tip of the slot die and the web in the standard coating process is represented by H1 and the wet-state film thickness of the coating film formed on the web is represented by h, H1 and h satisfy the relationship: h/H1<0.15.

25. The method for applying a coating solution according to claim 3, wherein,
provided that the clearance between the tip of the slot die and the web in the standard coating process is represented by H1 and the wet-state film thickness of the coating film formed on the web is represented by h, H1 and h satisfy the relationship: h/H1<0.15.

26. The method for applying a coating solution according to claim 5, wherein,
provided that the clearance between the tip of the slot die and the web in the standard coating process is represented by H1 and the wet-state film thickness of the coating film formed on the web is represented by h, H1 and h satisfy the relationship: h/H1<0.15.

27. The method for applying a coating solution according to claim 8, wherein,
provided that the clearance between the tip of the slot die and the web in the standard coating process is represented by H1 and the wet-state film thickness of the coating film formed on the web is represented by h, H1 and h satisfy the relationship: h/H1<0.15.

28. The method for applying a coating solution according to claim 12, wherein,
provided that the clearance between the tip of the slot die and the web in the standard coating process is represented by H1 and the wet-state film thickness of the coating film formed on the web is represented by h, H1 and h satisfy the relationship: h/H1<0.15.

29. The method for applying a coating solution according to claim 17, wherein,
provided that the clearance between the tip of the slot die and the web in the standard coating process is represented by H1 and the wet-state film thickness of the coating film formed on the web is represented by h, H1 and h satisfy the relationship: h/H1<0.15.

30. A method of manufacturing an optical film having at least one coating film layer formed by the method for applying a coating solution according to claim 1.

31. An apparatus for applying a coating solution by discharging a coating solution from a slit provided at a tip of a slot-die toward a surface of a web fitted onto a backup roller in continuous motion, thereby forming a crosslink bead of the coating solution in a clearance between the tip of the slot-die and the web, and applying the coating solution to the surface of the web via the bead,
the apparatus comprising:
a moving device which moves the slot die toward and away from the web;
a moving-speed regulating device which regulates a moving speed of the slot die by the moving device; and
a control device which controls the moving device to move the slot die to the coating initiation position having a smaller clearance than that of the standard coating process, and stay the slot die at the coating initiation position for a predetermined time, and thereafter, move the slot die to a standard coating position having a clearance of the standard coating process away from the coating initiation position.

32. The apparatus for applying a coating solution according to claim 31, wherein
the control device controls the moving device to stop the slot die at the coating initiation position for a retention time of 0.5 seconds or more.

33. The apparatus for applying a coating solution according to claim 31, wherein
the moving-speed regulating device regulates a moving speed of the slot die toward the coating initiation position to fall within the range of 3 mm/sec to 20 mm/sec and a moving speed of the slot die away from the coating initiation position to 3 mm/sec or less.

34. The apparatus for applying a coating solution according to claim 32, wherein
the moving-speed regulating device regulates a moving speed of the slot die toward the coating initiation position to fall within the range of 3 mm/sec to 20 mm/sec and a moving speed of the slot die away from the coating initiation position to 3 mm/sec or less.
